(19) United States
(12) Patent Application Publication
(10) Pub. No.: US 2014/0351108 A1
(43) Pub. Date: Nov. 27, 2014

(54) RENEWABLE ENERGY SPONSORSHIP AND FUNDING MODEL

(71) Applicant: OneEnergy, Inc., Seattle, WA (US)

(72) Inventors: Bryce Smith, Seattle, WA (US); Scott Ward Bixby, Seattle, WA (US); Travis Jonathan Bryan, Seattle, WA (US); William Michael Eddie, II, Portland, OR (US); Christopher John Watmore, Seattle, WA (US)

(21) Appl. No.: 13/902,486

(22) Filed: May 24, 2013

(51) Int. Cl. G06Q 30/04

(52) U.S. Cl. CPC G06Q 30/04
USPC 705/34

(57) ABSTRACT

A renewable energy sponsorship and funding model may allow an entity (“sponsor”) to sponsor creation and/or operation of a renewable energy source without necessarily receiving power directly from the renewable energy source. The sponsor may engage in a contract for differences (CFD) with the renewable energy source through a service provider. The sponsor may periodically make payments or receive payments resulting from the differences determined under the CFD. The amounts of the differences are variable based at least on the production of renewable energy by the renewable energy source and the wholesale market rates used in the purchase of power produced by the renewable energy source. These variances may be difficult to accommodate in a financial budget implemented by the sponsor. Various techniques and systems are disclosed to offset and/or smooth these variances, including making purchases on a wholesale spot market, using a credit facility, and/or creating a forward contract.

### BACKGROUND

Energy production and consumption is a forefront issue in many areas of the world. A trend in the United States is to reduce reliance on non-renewable energy, such as fossil fuels, while also reducing reliance on “dirty” energy production. A number of renewable energy sources provide clean energy, and thus do not cause air pollution, typical from burning oil and coal, and do not result in production of radioactive material, which is a byproduct of nuclear energy production. Examples of clean renewable energy sources include hydro power (from rivers, tides, rain, etc.), wind power, solar power, and geothermal power. Other types of renewable energy may be extracted by burning biomass (e.g., lumber, plants, etc.) or biofuels created from biomass (e.g., bio diesel, etc.); however, burning biomass and biofuels does result in pollution.

Besides the obvious environmental benefits of clean renewable energies, other benefits exist. Clean renewable energy can be produced in areas that do not support extraction or creation of other types of energy resources, such as fossil fuels or biomass. For example, a solar installation or wind farm may be used to create energy in a desert or otherwise arid environment that does not contain fossil fuels or biomass.

However, clean renewable energy sources do have some drawbacks. A first drawback is the need to locate clean renewable energy sources near customers that use the generated power since the power generated by these sources cannot be easily stored for later use. A second drawback is an upfront cost to build a renewable energy sources. Often, the initial costs of creating a clean renewable energy source would require the source to run for many years before the amount of energy produced offsets the initial costs. In some instances, clean renewable energy sources never produce enough energy to offset the costs of creating and maintaining the source. However, other factors may still make such sources viable, such as using these sources to create an independence from conventional energy sources and minimizing pollution to areas caused by use of dirty energy sources. A third drawback is a variance in production of energy from a renewable energy source, which may be dependent on uncontrollable natural events such as the generation of wind, the presence of sunlight, rainfall, and/or other natural events, which can vary over time and be difficult to accurately forecast.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative environment that includes entities that may participate in renewable energy source sponsorship and/or funding.

FIG. 2 is a flow diagram of an illustrative process showing exchange of power and funds between various entities including a sponsor of a renewable energy source and the renewable energy source.

FIG. 3 is a block diagram of an illustrative computing architecture of a service provider that implements a renewable energy source sponsorship and funding model.

FIGS. 4A and 4B show illustrative graphs showing a fixed rate for renewable energy and a variable wholesale market rate for power supplied by a wholesale market. FIG. 4A also shows a power supply agreement that includes a fixed price for an interval of time. FIG. 4B shows the market rate being smoothed or offset using one or more techniques of the funding model.

FIG. 5 is a flow diagram of an illustrative process to implement a contract for differences (CFD) to fund the renewable energy source by the sponsor.

FIG. 6 is a flow diagram of an illustrative process to smooth or offset differences resulting from the CFD to facilitate budgeting by the sponsor of the renewable energy source.

FIG. 7A is a flow diagram of an illustrative process to purchase energy on a wholesale spot market to smooth or offset differences resulting from the CFD.

FIG. 7B is a flow diagram of an illustrative process to use a credit facility to smooth or offset differences resulting from the CFD.

FIG. 7C is a flow diagram of an illustrative process to create a forward contract for sale of some power generated by the renewable energy source to smooth or offset differences resulting from the CFD.

FIG. 8 is a flow diagram of an illustrative process to trade renewable energy credits (RECs) associated with the renewable energy source.

FIG. 9 is a flow diagram of another illustrative process to trade renewable energy credits (RECs) associated with the renewable energy source.

### DETAILED DESCRIPTION

### Overview

This disclosure is directed to providing, implementing, and supporting a renewable energy sponsorship and funding model. The model may allow an entity (“sponsor”) to sponsor creation and/or operation of a renewable energy source without necessarily receiving power directly from the renewable energy source. The sponsor may be a non-utility entity. Examples of sponsors include, without limitation, universities, corporations, non-profit organizations and other groups that are not licensed to trade electricity or supply electricity in the wholesale or retail market. The sponsor may engage in a contract for differences (CFD) with the renewable energy source through a service provider. As consideration, the sponsor may receive renewable energy credits (RECs) 120, naming rights, and/or other benefits. Once the CFD is in effect, the sponsor may periodically make payments or receive payments resulting from the differences determined under the CFD. The amounts of the differences are variable based at least on the production of renewable energy by the renewable energy source and wholesale market rates used in the purchase of power produced by the renewable energy source. These variances may be difficult to accommodate in a financial budget implemented by the sponsor.

Accordingly, various techniques and systems are disclosed herein to offset and/or smooth these variances. In various embodiments, the service provider may facilitate purchase of energy by the sponsor on a wholesale spot market to smooth or offset differences resulting from the CFD. By purchasing energy on the wholesale spot market, the sponsor may effectively absorb or offset at least some of the variability of the energy market rate during an interval of time. For example, the sponsor may purchase energy on the spot market at a low market rate to offset a large difference payment that may be due under the CFD because of the low market price of power at a given point in time.

In some embodiments, the service provider may facilitate use of a credit facility to smooth or offset differences that result from the CFD for the sponsor. The credit facility may provide funds to the sponsor to offset at least part of an amount due by the sponsor under the CFD while requiring the sponsor to make payments toward the credit when the terms of the CFD are more favorable to the sponsor.

In accordance with one or more embodiments, the service provider may facilitate creation of a forward contract for sale of some power generated by the renewable energy source to remove some variability occurring under the CFD based on the production of the power by the renewable energy source and/or variances in the wholesale market rate used to purchase the power. By having a known fixed rate for some of production of energy by the renewable energy source, the sponsor may be able to more accurately forecast a budget under the CFD.

The service provider may assist in trading of renewable energy credits (RECs) under the CFD. In some embodiments, the CFD may include an exchange of RECs of a first type for RECs of a second type during a term of the CFD. For example, during a first term of the CFD, solar power RECs received during the term may be exchanged for wind power RECs, which may then be provided to the sponsor. After the expiration of the term, the sponsor may then receive solar power RECs for energy produced after conclusion of the term. The exchange of RECs may be beneficial due to differences in values of various types of RECs. For example, solar power RECs may be more valuable than wind power RECs during a period of time.

The techniques and systems described herein may be implemented in a number of ways. Example implementations are provided below with reference to the following figures.

### Illustrative Environment

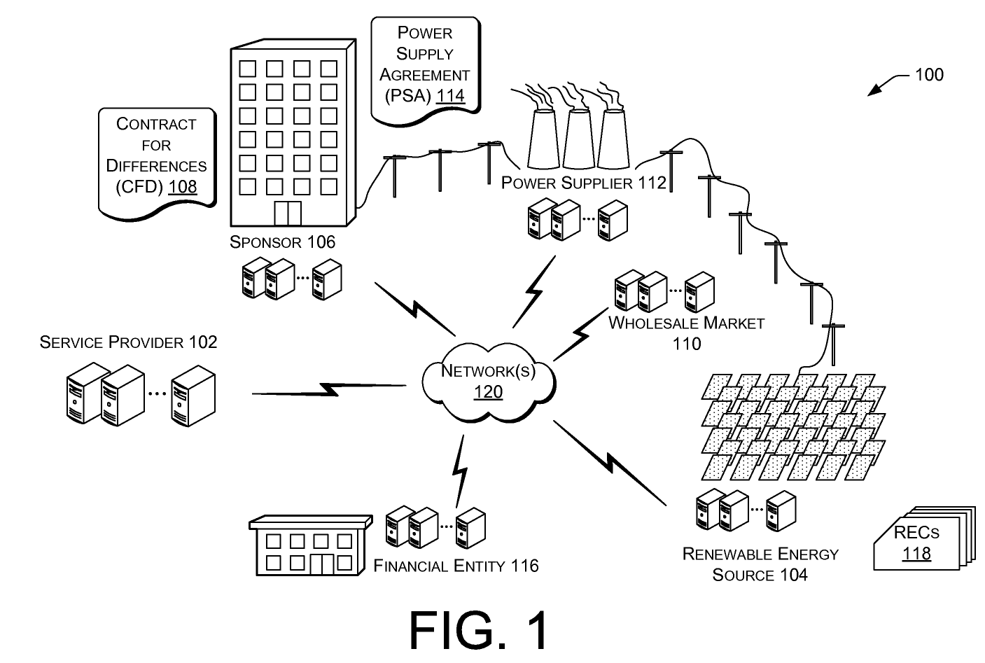

FIG. 1 is a schematic diagram of an illustrative environment 100 that includes entities that may participate in renewable energy source sponsorship and/or funding. The environment 100 may include a service provider 102 that facilitates creation and/or operation of a renewable energy source 104, which may be initiated as a renewable energy project. The renewable energy source 104 may be any source of renewable energy, such as solar power, wind power, geothermal power, and/or other types of renewable energy sources which require large amounts of capital investment to create the source, and thus long term investments to ensure production of the renewable energy for many years. These investments may or may not be profitable for an investor (e.g., a sponsor) over time, and particularly may not be profitable during an initial part of a term (e.g., for the first few of years or more). Although this disclosure focuses on a renewable energy source of solar power, the techniques and systems discussed herein may be used with other types of renewable energy sources or combinations of renewable energy sources.

The service provider 102 may engage a sponsor 106, or possibly multiple sponsors, to engage in a contract to provide financial support for the renewable energy source 104 over a term without the sponsor 106 necessarily receiving energy directly from the renewable energy source 104. The sponsor 106 is therefore an investor or backer for the renewable energy source 104 to guarantee money to enable the renewable energy source 104 to continue operation over the term. For example, the sponsor 106 may engage in a contract for difference (CFD) 108 over a term of many years to make a payment to or receive a payment from the renewable energy source 104 for a difference of a wholesale market rate for power and a fixed rate specified in the CFD 108 for power produced during a period of time. For example, when the price of power purchased by a wholesale market 110 is less than the fixed rate in the CFD 108, then the sponsor 106 may make payments of the difference to the renewable energy source 104, the service provider 102, or another interested party or parties designated in the CFD 108. However, when the price of power purchased by a wholesale market 110 is greater than the fixed rate in the CFD 108, then the sponsor 106 may receive payments (receivables) for the difference. As consideration for entering into the CFD 108, the sponsor 108 may receive renewable energy credits (RECs), naming rights, and/or other benefits after entering into the CFD 108 with the renewable energy provider 104, and possibly also entering into the CFD 108 with the service provider 102, who may facilitate at least some of the operations specified in the CFD 108.

Due to regulations, geographic constraints, and/or other reasons, the sponsor 106 may not be able to purchase power directly from the renewable energy source 104. However, the sponsor 106 may purchase power and receive power from a power supplier 112. The sponsor 106 may engage in a power supply agreement (PSA) 114 with the power supplier 112 to purchase power at a fixed retail rate (or term rate) over a term specified in the PSA 114. For example, the term may extend a number of weeks, months, or years. Typically, the term is a year, but other terms may be used. However, the sponsor 106 may engage in shorter term usage agreements or pay-as-you-go arrangements, such as typical with smaller entities and residential customers. Using the PSA 114, the sponsor 106 may be able to create an accurate budget for expenses from power consumption under the PSA 114. However, the sponsor 106 may be unable to create an accurate budge for expenses or income under the CFD because of variability due to changes in the wholesale market price from the wholesale market 110, the production of the renewable energy by the renewable energy source 104, and/or other variables. This variability may be disruptive and/or problematic for the sponsor 106. To lessen the variability, the service provider 102 may offset and/or smooth the differences resulting from the CFD 108 using one or more techniques discussed herein. In some instances, other entities, such as a financial entity 116 may participate with the service provider 102 to provide at least part of the offset or smoothing of the differences resulting from the CFD 108.

In some embodiments, the service provider 102 may facilitate an exchange and/or a conversion of renewable energy credits (RECs) 118 on behalf of the sponsor 106. The CFD 108 may designate an exchange of RECs of a first type for RECs of a second type during a term of the CFD. For example, during a first term of the CFD 108, solar power RECs received during the term may be exchanged by the service provider 102 for wind power RECs, which may then be provided to the sponsor 108. After the expiration of the term, the sponsor 106 may then receive solar power RECs for energy produced after conclusion of the term. The exchange of RECs may be beneficial due to differences in values of various types of RECs. For example, solar power RECs may be more valuable than wind power RECs during a period of time.

As shown in FIG. 1, some or all of the entities may communicate with each other and/or with the service provider 102 via one or more networks 120. The networks 120 may facilitate at least exchange of data, exchange of payments, exchange of power consumption, and/or a combination thereof

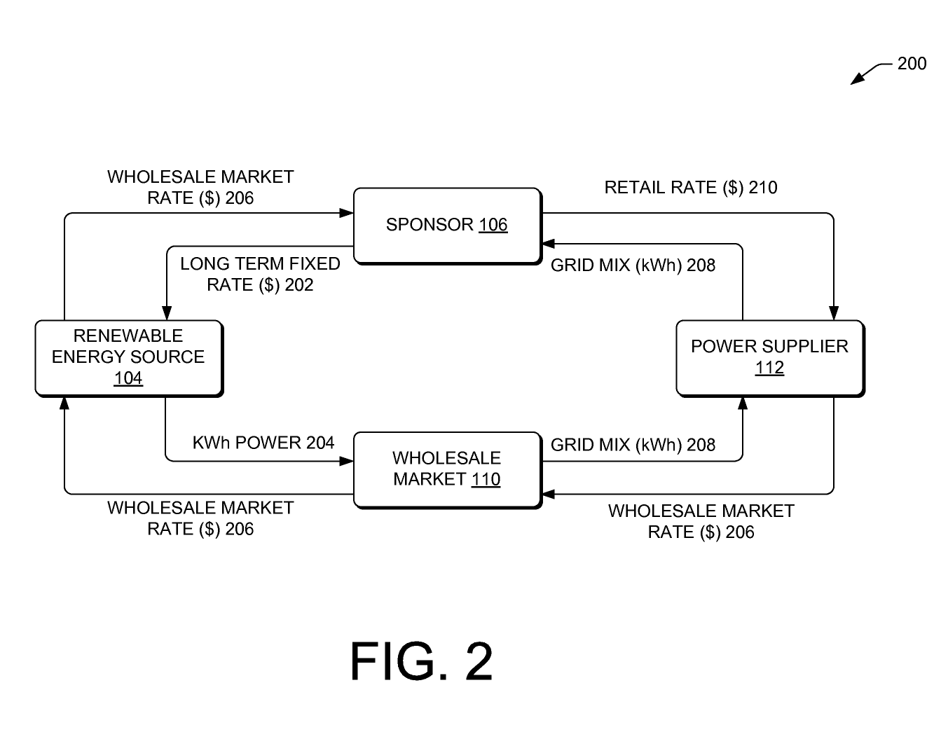

FIG. 2 is a flow diagram of an illustrative process 200 showing exchange of power and funds between the sponsor 106 of the renewable energy source 104, the renewable energy source 104, the power supplier 112 and the wholesale market 110. The process 200 may be implemented using the environment 100 or the process may be implemented in other environments. The service provider 102 is not directly shown in FIG. 2 for simplification of the basic operations. The service provider 102, however, may be directly or indirectly involved in some or all operations of the process 200.

As discussed above, the sponsor 106 may engage in the CFD 108 with the renewable energy source 104 to establish a long term fixed rate 202 for energy produced by the renewable energy source 104. The rate may be a rate per Watt hour (W·h) of power produced by the renewable energy source 104. As the renewable energy source produces power 204, the power may be sold on the wholesale market 110 for the wholesale market rate 206, which may be a best available rate at a given moment in time. Because it is difficult or not feasible to store energy produced by the renewable energy source 106, the wholesale market rate typically corresponds to the rate when the power is produced and provided to a power supplier via a transaction involving the wholesale market 110. The renewable energy source 104 may then provide at least a portion of the wholesale market rate 206 received from the wholesale market 110 to the sponsor 106. Thus, the exchange of payments between the renewable energy source 104 and the sponsor 106 is governed by the CFD 108 and includes one or both of payments of at least part of the long term fixed rate 202 and at least part of the wholesale market rate 206.

Meanwhile, the power supplier 112 may purchase a grid mix 208 of power from the wholesale market 110 at the current wholesale market rate 206. The grid mix 208 may include some power generated by the renewable energy source 104 or the grid mix 208 may not include any power generated by the renewable energy source. In some embodiments, a wholesale market that purchases the power from the renewable energy source 104 may be different than a wholesale market that supplies power to the power supplier 112. The power supplier 112 may engage into the PSA 114 with the sponsor to fix a retail rate 210 for power over a term. Thus, the sponsor 106 may purchase power from the power supplier at the retail rate 210 while the power supplier 112 may purchase the power (the grid mix 208) at a wholesale market rate 208 that may be different (higher or lower) than the retail rate. While the wholesale market rate 206 is subjected to market volatility and may change by the minute or any other period of time the retail rate 210 is governed by the PSA 114 and may not vary until expiration of the term specified in the PSA 114 when a new retail rate may be established. Thus, the sponsor 106 may be shielded from the variability of the wholesale market rate 206 by the PSA 114. However, the sponsor 106 is not shielded from the wholesale market rate 206 through interactions involving the CFD 108 with the renewable energy source 104. This creates variability in payments or receivables by the sponsor 106, which may disrupt budgeting processes or otherwise be undesirable by the sponsor 106. Thus, various techniques are discussed below to offset and/or smooth the variances resulting from fluctuations of the wholesale market rate 206 under the CFD 108.

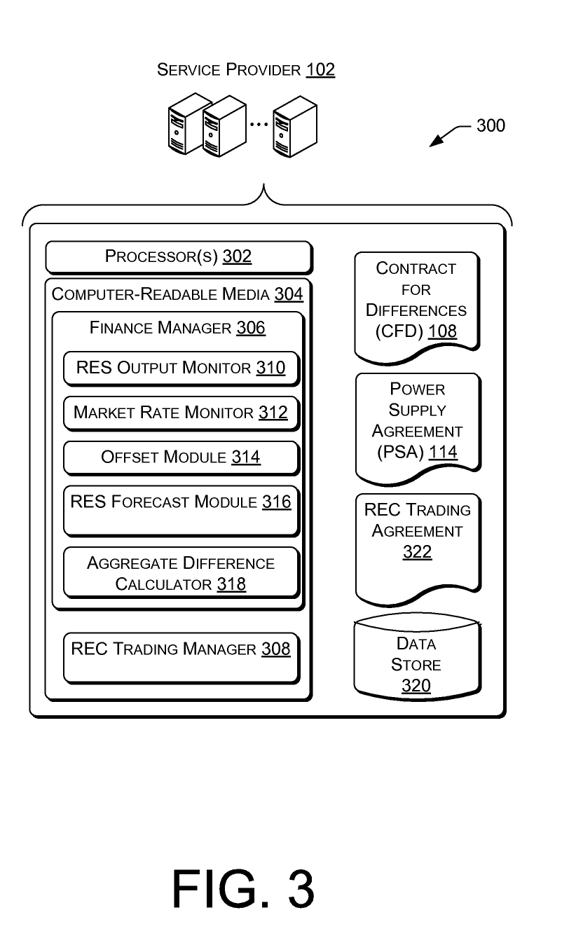

FIG. 3 is a block diagram of an illustrative computing architecture 300 of the service provider 102 that implements a renewable energy sponsorship and funding model. The computing architecture 300 may be implemented in a distributed computing environment (e.g., server farm, cloud computing service, etc.) or non-distributed computing environment, which each may include an arrangement of servers or other types of computing devices. The computing architecture 300 may include processor(s) 302 and computer-readable media 304. The computer-readable media 304 may store various modules, applications, programs, or other data to facilitate the processes discussed herein. The computer-readable media 304 may include instructions that, when executed by the processor(s) 302, cause the processor(s) to perform the operations described herein for the service provider 102. In some embodiments, the computer-readable media 304 may store a finance manager 306 that includes additional components, discussed in turn, to cause at least some of the operations discussed herein. The computer-readable media 304 may store a REC trading manager 308 to facilitate trading of RECs. The additional components of the finance manager 306 may include one or more of a renewable energy source (RES) output monitor 310, a market rate monitor 312, an offset module 314, a RES forecast module 316, or an aggregate difference calculator 318. Thus, in some embodiments, the additional components may only include some of the components and not others, while in other embodiments the additional components may include all of the components.

The RES output monitor 310 may monitor or track the power 204 output by the renewable energy source 104. The RES output monitor 310 may store the monitored or tracked output in a datastore 320, and associate the output with a time of the output or time of consumption of the output by the wholesale market 110.

The market rate monitor 312 may monitor or track the wholesale market rate 206 and associated amount of power from the renewable energy source 104 purchased at each instance of the wholesale market rate 206 by the wholesale market 110. The market rate monitor 312 may store the monitored or tracked rates and output in the datastore 320. Thus, the RES output monitor 310 and the market rate monitor 312 can be used facilitate calculation of amounts due under the CFD 108 and/or forecasts involving future production of power.

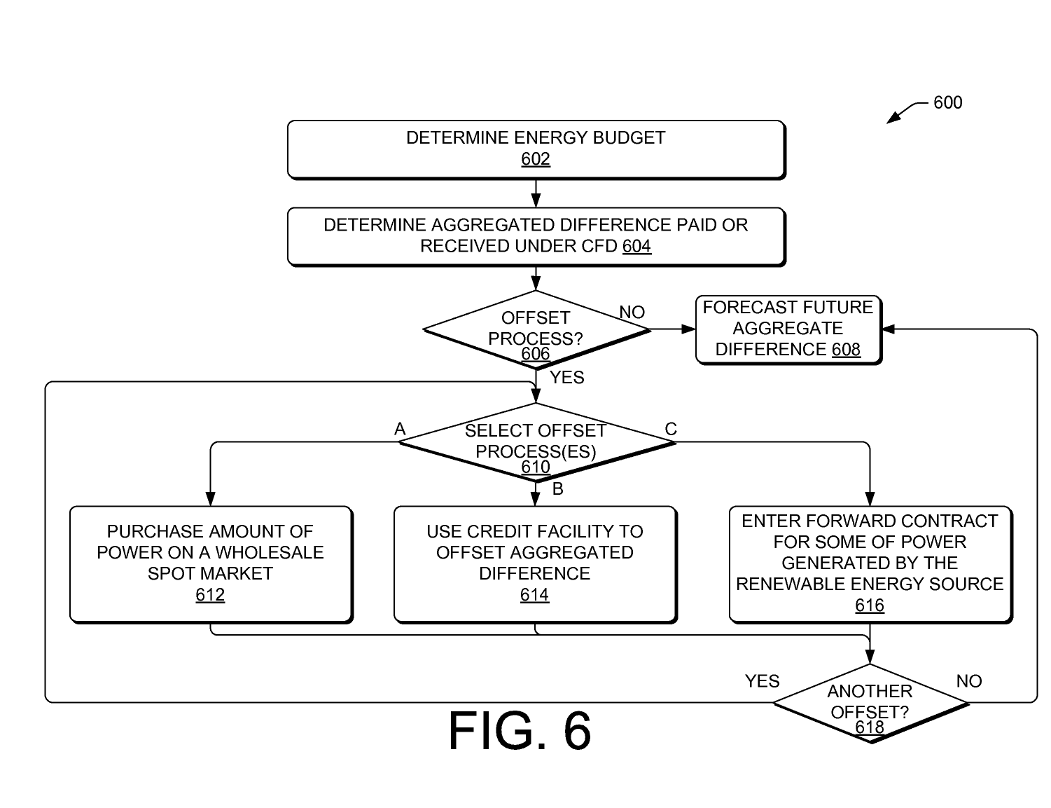

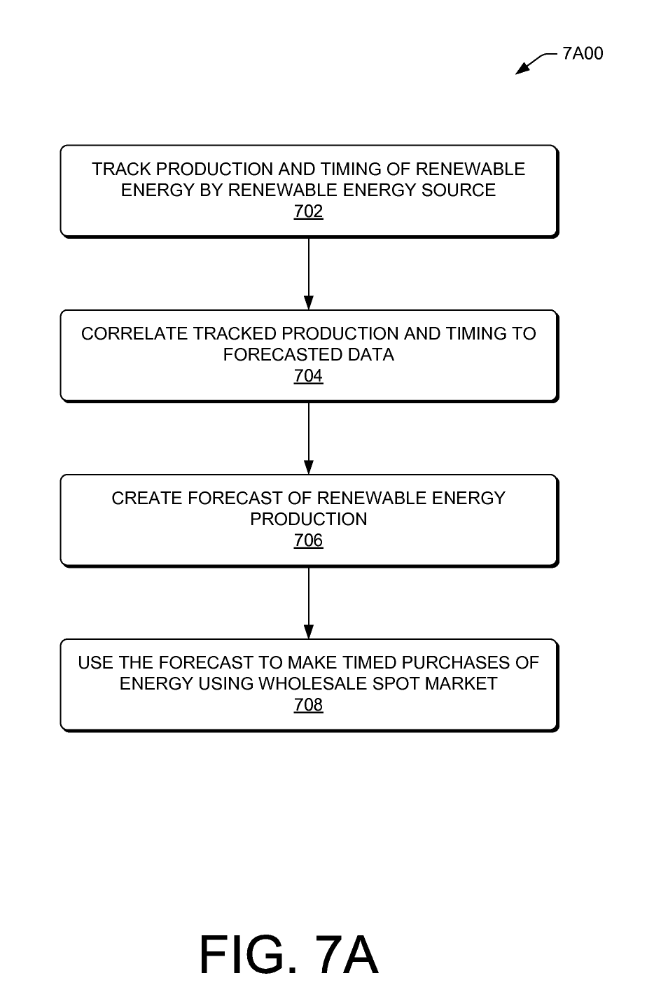

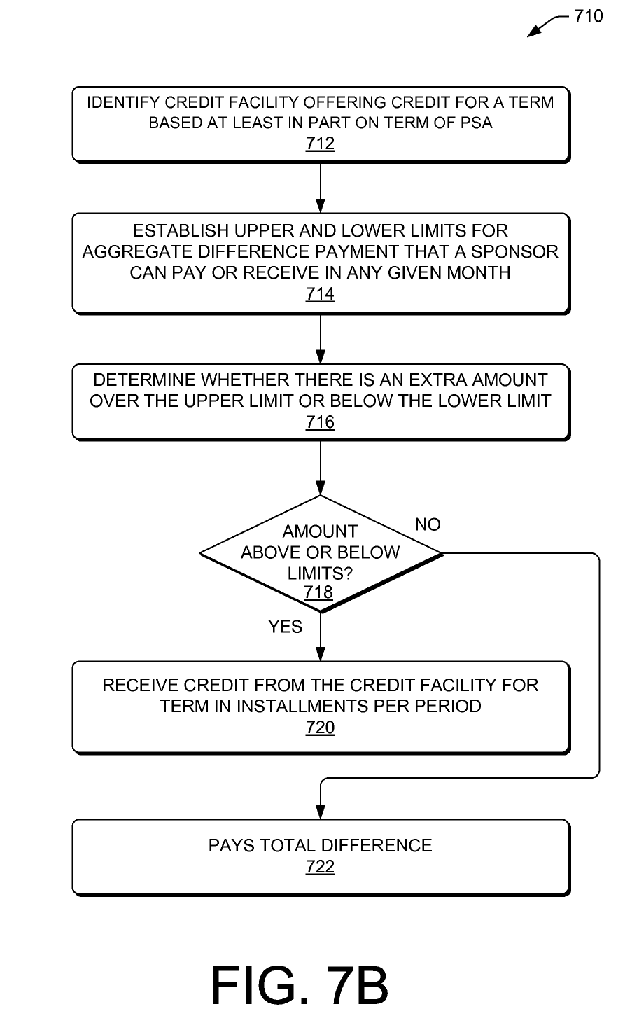

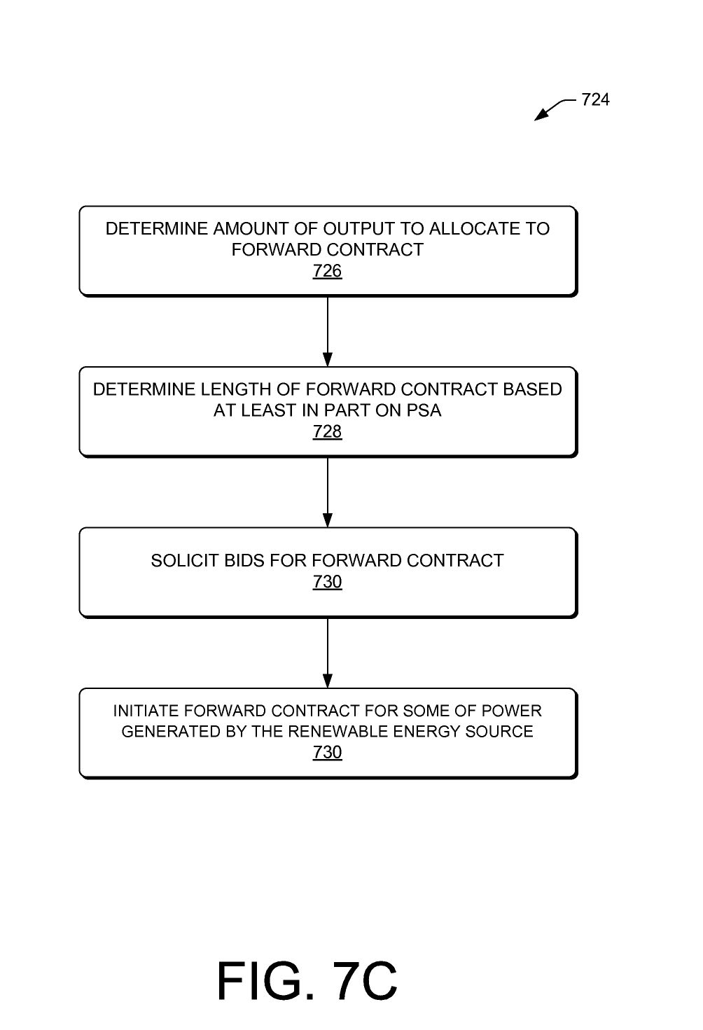

The offset module 314 may be used to implement and/or facilitate offsets and/or smoothing, as discussed in detail below in FIGS. 6 and 7A-7C, to modify amounts due by the sponsor 106 or receivables due to the sponsor 106 in association with the CFD 108. In various embodiments, the offset module 314 may facilitate purchase of energy by the sponsor 106 on a wholesale spot market to smooth or offset differences resulting from the CFD 108, interact with a credit facility (e.g., the financial entity 116, etc.) to smooth or offset differences resulting from the CFD 108, facilitate creation of a forward contract for sale of some power generated by the renewable energy source 104, or a combination thereof.

The RES forecast module 316 may forecast the amount of power expected to be produced by the renewable energy source 104 for a term. The forecast may be used for budgeting purposes and/or to improve the offsets produced by the offset module 314, as discussed below. For example, the forecast of power produced by a renewable energy source that generates solar power may include an expected increase in production of power during the summer when days are longer and thus more sunlight can be converted to power. Various inputs may be used to create the forecast, such as weather forecasts, historical data, and/or specifications for the renewable energy source 106 (e.g., expected baseline outputs, collection units, etc.).

The aggregate difference calculator 318 may determine a payment due by the sponsor 106 and/or a receivable due to the sponsor 106 during a term. The aggregate difference calculator 318 may determine the aggregate difference based on the CFD 108 and any offsets implemented by the offset module 314.

In various embodiments, the computer-readable media 304 may store the REC trading manager 308 to assist in trading of renewable energy credits (RECs) under the CFD. The REC trading manager 308 may operate in accordance with a REC trading agreement 322 that may be included in the CFD 108 or may be associated with the CFD 108 and managed in part by the service provider 102.

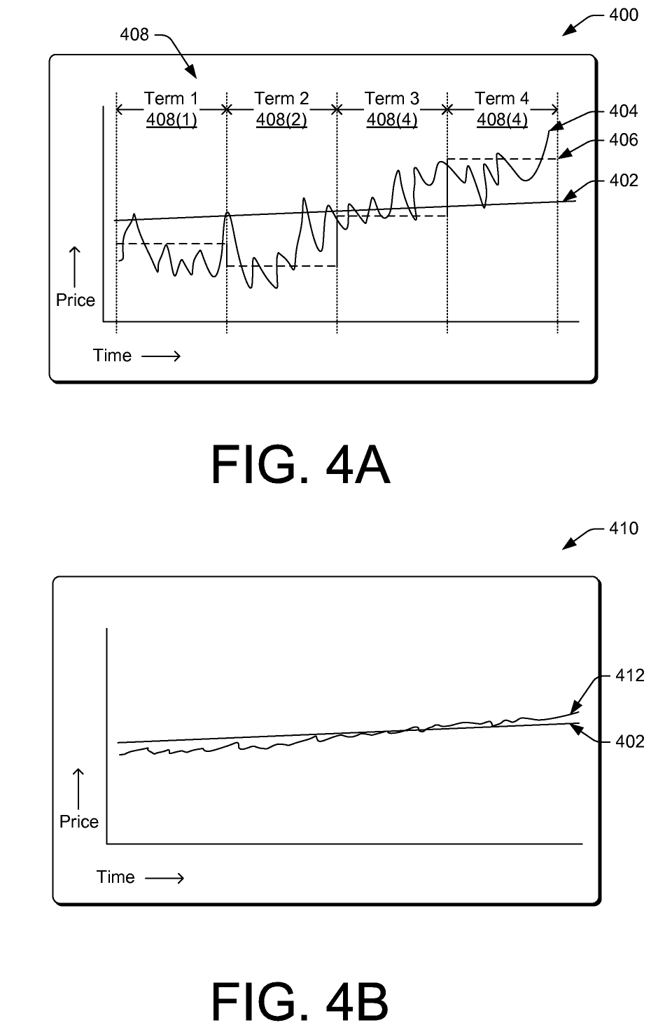

FIG. 4A shows an illustrative graph 400 that plots various illustrative values over time. The graph 400 includes a fixed rate plot 402 representing the fixed rate 202 for renewable energy based on the CFD 108. The fixed rate plot 402 may increase over time, include steps over time, or include other features (e.g., variations based on amounts of energy produced, caps, minimum payments, etc.).

The graph 400 also includes a market rate plot 404 representing the wholesale market rate 206 over time for power purchased by the wholesale market 110 from the renewable energy source 104. As discussed above, the market rate 206 may be volatile, and thus the market rate plot 404 reflects this volatility.

The graph 400 also includes a retail rate plot 406 (dashed line) representing the retail rate 210 over time for power purchased by the sponsor 106 from the power source 112. The retail rate plot 406 shows steps, each of a predetermined length specified in the PSA 114. Thus, the retail rate plot 406 shows a locked in rate paid by the sponsor 106 for energy during each term.

In the graph, the aggregate difference between the fixed rate plot 402 and the market rate plot 404 may determine at least part of an amount owed by the source 106 or a receivable to be paid to the source 106. In contrast, the retail rate plot 406 incurred by the source 106 does not vary during a term specified in the PSA 114 regardless of variance in the wholesale market rate 206. However, the retail rate plot 406 may be adjusted periodically, typically by implementing a new PSA, based on the trends of the wholesale market rate 206. Thus, the retail rate plot 406 loosely follows the market rate plot 404.

The graph 400 shows sample terms 408 that correspond to the terms in the PSA 114 for the retail rate 210. A first term 408(1) shows an aggregate difference between the fixed rate plot 402 and the market rate plot 404 where the fixed rate 202 is greater than the wholesale market rate 206, thus resulting in a payment by the sponsor 106 to the renewable energy source 104. A second term 408(2) shows a reduction in the fixed rate 202 based on the PSA 114. Again the fixed rate 202 is greater than the wholesale market rate 206, thus resulting in a payment by the sponsor 106 to the renewable energy source 104. The net expenditures for the sponsor 106 may be different across the second term 408(2) and different than the expenditures from the first term 408(1), resulting in budget shortfalls or inaccuracy. A third term 408(3) shows an increase in the fixed rate 202 based on the PSA 114. The fixed rate 202 is less than the whole market rate 206 for most of the third term 408(3), likely resulting in a receivable by the sponsor 106 from the renewable energy source 104 or from another entity (e.g., the service provider 102, the wholesale market 110, the financial entity 116, etc.). The net expenditures for the sponsor 106 may be different across the third term 408(3) and different than the expenditures from the first term 408(1) and the second term 408(2). However the increase of the wholesale market rate 206, which impacts the retail rate set in the PSA 114, is partially offset by the refund or reduced payment required under the CFD 108 in the third term 408(3). Likewise, a fourth term 408(4) may include another raise in the retail rate, which may again result in different expenditures by the sponsor over the term due to volatility in the wholesale market rate 206. Thus, is may be desirable to effectively smooth the wholesale market rate 206 and/or offset the variance between the fixed rate 202 (the fixed rate plot 402) and the wholesale market rate 206 (the market rate plot 404).

FIG. 4B shows an illustrative graph 410 that plots the fixed retail plot 402 and an adjusted effective market rate plot 412. The aggregate difference between the adjusted effective market rate plot 412 and the fixed rate plot 402 is an amount paid by the sponsor 106 to the renewable energy source 104 when the fixed rate plot 402 is greater than the adjusted effective market rate plot 412. When the fixed rate plot 402 is less than the adjusted effective market rate plot 412, the sponsor 106 may receive a payment. The smoothing and/or offset that reduce the difference between the fixed rate plot 402 and the adjusted effective market rate plot 412 may be a resultant of the smoothing and/or offset techniques deployed in part by the offset module 314 and are discussed in further detail below. The reduced difference allows the sponsor 106 to more accurately budget costs associated with power consumption under the PSA 114 and sponsorship of the renewable energy source 104 via the CFD 108, and thus makes sponsorship of the renewable energy source 104 a more viable investment particularly for entities that have sensitivity to budget fluctuations.

### Illustrative Operations

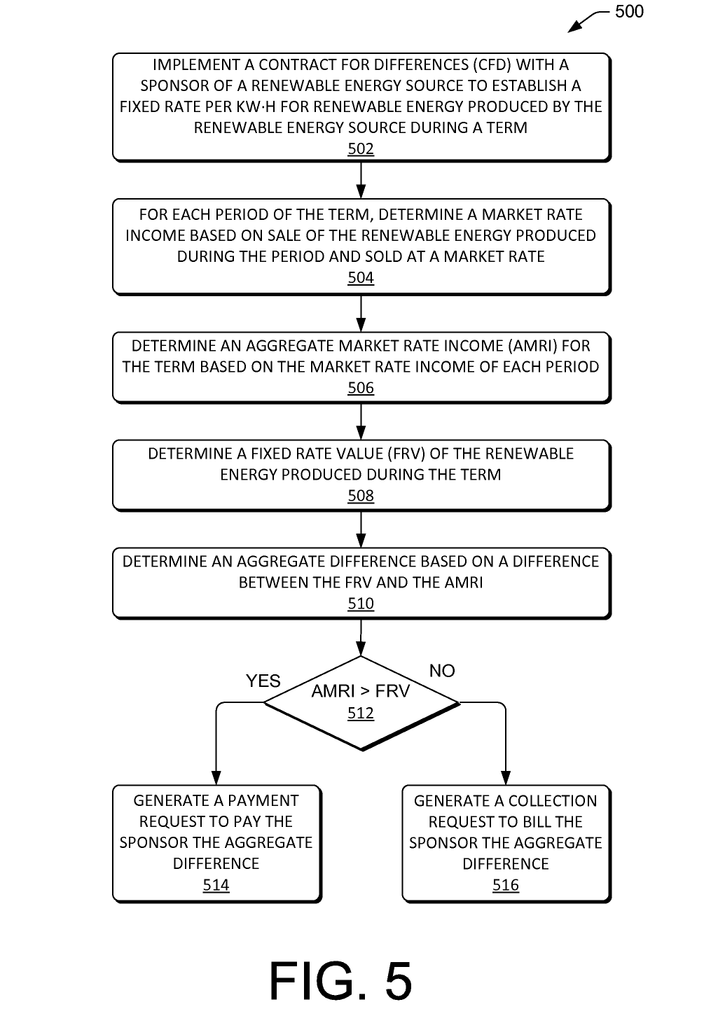

FIGS. 5-8 show processes to provide renewable energy source sponsorship and funding. The processes are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 5 is a flow diagram of an illustrative process 500 to implement a contract for differences (CFD) to fund the renewable energy source 104 by the sponsor 106. The process 500 may be implemented using the environment 100 and the computing architecture 300 or the process may be implemented in other environments using other computing architecture. The process 500 may be performed in part by the finance manager 306 and various components associated therewith.

At 502, the service provider 102 may implement the CFD 108 with the sponsor 106 of the renewable energy source 104 to establish a fixed rate per kW·h for renewable energy produced by the renewable energy source 104 during a term specified by the CFD 108. The service provider 102 may implement the CFD 108 in part by pairing or matching the sponsor 106 (or sponsors) with the renewable energy project (which, when operational is the renewable energy source 104).

At 504, for each period of the term, the service provider 102 may determine a market rate income based on sale of the renewable energy produced by the renewable energy source 104 during the period and sold to the wholesale market 110 at the wholesale market rate 206. The operation 504 may occur multiple times (via a loop) to accommodate each period of the term. For example, the period may be intervals of minutes, hours, units of power, etc., and may be the same or different in length.

At 506, the service provider 102 may determine an aggregate market rate income (AMRI) for the term based on the market rate income of each period, as determined via iterations of the operation 504 discussed above.

At 508, the service provider 102 may determine a fixed rate value (FRV) of the renewable energy produced during the term. The FRV may be the amount of power produced by the renewable energy sources 104 at the fixed rate 202.

At 510, the service provider 102 may determine an aggregate difference based on a difference between the FRV and the AMRI.

At 512, when the AMRI is greater than the FRV (following the “yes” route from the decision operation 512), then the process 500 advances to an operation 514. At 514, the service provider 102 may facilitate generating a payment request to pay the sponsor 106 the aggregate difference. At 512, when the AMRI is not greater than the FRV (following the “no” route from the decision operation 512), then the process 500 advances to an operation 516. At 516, the service provider 102 may facilitate generating a collection request to bill the sponsor 106 the aggregate difference.

FIG. 6 is a flow diagram of an illustrative process 600 to smooth or offset differences resulting from the CFD 108 to facilitate budgeting by the sponsor 106 of the renewable energy source 104. The process 600 may be implemented using the environment 100 and the computing architecture 300 or the process may be implemented in other environments using other computing architecture. The process 600 may be performed in part by the finance manager 306 and various components associated therewith.

At 602, the service provider 102 may determine an energy budget of the sponsor 106. The energy budget may include the retail rate 410 and payment to be made by the sponsor 106 under the PSA 114 for power supplied to the source 106 from the power supplier 112, among other possible elements of the energy budget.

At 604, the service provider 102 may determine the aggregate difference paid or received under the CFD 108, such as by implementing, in whole or in part, the process 500.

At 606, the service provider 102 may determine whether to provide an offset (including smoothing operations) to reduce variance in payments by the sponsor 106 for power under the PSA 114 and the CFD 108. For example, when the variance caused by the CFD 108 is large in comparison to total payments (or a total budget) including the PSA, then the sponsor 106 may desire to offset the variance to create a more consistent and predictable expenditure for power under the PSA 114 and the CFD 108. When the service provider 102 does not determine to process an offset (following the “no” route from the decision operation 606), then the process 600 may advance to an operation 608 where the service provider 102 may estimate a future aggregate difference 608 which may be used by the sponsor 106 for budgeting purposes. When the service provider 102 does determine to process an offset (following the “yes” route from the decision operation 606), then the process 600 may advance to an operation 610 where the service provider 102 may select one or more offset processes to perform to reduce the variance in payment by the sponsor 106 for power under the PSA 114 and the CFD 108. The decision operation 610 may allow the service provider 102 to select and implement, possibly in part by action from other entities including the sponsor 106 and/or financial entity 116, an offset process following one or more of the routes “A,” “B,” or “C.”

At 612 (following route “A” from the decision operation 610), the service provider 102 may initiate purchase of an amount of power on a wholesale spot market on behalf of the sponsor 106 or otherwise initiate the purchase by the sponsor 106. The amount of power purchased may offset the variability of the difference between the fixed rate 402 and the wholesale market rate 406 because the sponsor 106 may effectively purchase power cheaper on the spot market (and thus save money) when the fixed rate 402 is higher than the wholesale market rate 406 (causing the sponsor 106 to incur a payment to the renewable energy source 104). The sponsor 106 may buy low on the spot market when the CFD 108 would result in a large payment at that point in time, thus offsetting one another. The operation 612 is described in further detail with reference to FIG. 7A.

At 614 (following route “B” from the decision operation 610), the service provider 102 may initiate use of a credit facility (e.g., the financial entity 116, etc.) to offset the aggregated difference. The credit facility may provide loans to the sponsor 106 to offset shortfalls when the sponsor 106 has to make large payments to the renewable energy source 104 under the CFD 108, while requiring the sponsor 106 to make repayments to the credit facility when the sponsor 106 has smaller payments or receivables from the renewable energy source 104 under the CFD 108. By providing the credit to the sponsor 106, the sponsor 106 may reduce the variance in payments by the sponsor 106 for power under the PSA 114 and the CFD 108 since a term having large payments (via the PSA 114) is often followed by a subsequent term having a lowered the rate in the PSA 114, thus resulting in a budget surplus by the sponsor 106. This phenomenon also allows repayment to the credit facility during the subsequent term. The operation 614 is described in further detail with reference to FIG. 7B.

At 616 (following route “C” from the decision operation 610), the service provider 102 may initiate entry by the sponsor 106 into a forward contract for sale of some of power generated by the renewable energy source 104, thus reducing the amount of power sold at the wholesale market rate 206 and incurring variability. The operation 616 is described in further detail with reference to FIG. 7C.

Flowing any of the operations 612, 614, or 616, the process 600 may advance to a decision operation 618 to determine whether to initiate or apply another offset. When another offset is applied (following the “yes” route from the decision operation 618), then the process 600 may return to the decision operation 610 to select an offset. When no further offsets are applied (following the “yes” route from the decision operation 618), then the process 600 may advance to the operation 608.

FIG. 7A is a flow diagram of an illustrative process 700 to purchase energy on a wholesale spot market to smooth or offset differences resulting from the CFD 108. The process 700 may provide additional sub-operations to perform the operation 612 of the process 600. The process 700 may be implemented using the environment 100 and the computing architecture 300 or the process may be implemented in other environments using other computing architecture. The process 500 may be performed in part by the offset module 314 of the finance manager 306.

At 702, the service provider 102 may track production and timing of the production of renewable energy produced by the renewable energy source 104. The service provider 102 may use the RES output monitor 310 to perform the tracking, which may receive feeds of outputs by the renewable energy source 104 as the output occurs and the power is sold on the wholesale market 110.

At 704, the service provider 102 may correlate the tracked production and timing of the production of the renewable energy power to forecast drivers. The forecast drivers maybe forecasted weather data, historical data, specifications for the renewable energy source 106 (e.g., expected baseline outputs, collection units, etc.). The RES forecast module 316 may track and store the forecast drivers that are correlated to the tracked production and timing of the production data.

At 706, the service provider 102 may use the RES forecast module 316 to create a forecast of the renewable energy production and timing expected for the renewable energy source over a given term, such as over a next set of months, a year, and/or other lengths of time. The forecast may include expected units of power to be produced for a period of time, which may be as granular as per minute, hour, or day.

At 708, the service provider 102 may facilitate making purchases of power using the forecast to purchase an equivalent amount of power as an amount of power produced by the renewable energy source, thereby offsetting the variance between the fixed rate 202 and the wholesale market rate 206 over at least part of a term. The purchases may be times so that the purchases correlate with the amount of power produced by the renewable energy source 104. The level of the correlation (e.g., frequency of purchases) may impact the smoothing, but may also result in additional expenses (e.g., transaction fees, etc.).

FIG. 7B is a flow diagram of an illustrative process 710 to use a credit facility to smooth or offset differences resulting from the CFD 108. The process 710 may provide additional sub-operations to perform the operation 614 of the process 600. The process 710 may be implemented using the environment 100 and the computing architecture 300 or the process may be implemented in other environments using other computing architecture. The process 710 may be performed in part by the offset module 314 of the finance manager 306.

At 712, the service provider 102 may identify a credit facility (e.g., the financial entity 116, etc.) that offers credit for a term that corresponds to the term of the PSA 114. For example, the service provider 102 may identify a credit facility willing to provide a short term loan to the sponsor 106 for the term to cover large payments due by the sponsor 106 under the CFD 108. The sponsor 106 may at least partially repay the credit facility over a next term when the sponsor 106 is expected to have a budget surplus under a new PSA.

At 714, the service provider 102 may establish upper and lower limits for the aggregate difference payment that a sponsor 106 can pay or receive in any given period of time (e.g., month, quarter, etc.). The upper and lower limits may be thresholds that trigger use of the credit from the credit facility. Thus, the sponsor 106 may be willing to have a threshold amount of variance in its budget. However, when the aggregate difference is expected to exceed the upper limit or fall below the lower limit, the service provider 102 may initiate use of the credit facility.

At 716, the service provider 102 may determine whether the sponsor 106 is to be charged an extra amount over the upper limit or below the lower limit (including receivables).

At 718, when the amount is above or below the limits (thresholds) as determined by the operation 716 (following the “yes” route from the decision operation 718), then the process 710 may advance to an operation 720. At 720, the service provider 102 may initiate receipt, by the sponsor 106, of credit from the credit facility for the term in installments issued per period (based on the budgeting needs, etc.). The service provider 102 may then initiate repayment of the credit by the sponsor 106 during a subsequent term. The installments may be equal installments, based on needs at each period, or based on other factors.

At 718, when the amount is not above or below the limits (thresholds) (following the “no” route from the decision operation 718), then the process 710 may advance to an operation 722. At 722, the service provider 102 may decline or otherwise recommend against use of the credit facility during that particular term.

FIG. 7C is a flow diagram of an illustrative process 724 to create a forward contract for sale of some power generated by the renewable energy source 104 to smooth or offset differences resulting from the CFD 108. The process 724 may provide additional sub-operations to perform the operation 616 of the process 600. The process 724 may be implemented using the environment 100 and the computing architecture 300 or the process may be implemented in other environments using other computing architecture. The process 724 may be performed in part by the offset module 314 of the finance manager 306.

At 726, the service provider 102 may determine an amount of power output by the renewable energy source 104 (and under the CFD 108) to be allocated to a buyer in a forward contract for the output of power by the renewable energy source 104. For example, the service provider 102 may determine the amount as a percentage of the total amount of power output by the renewable energy source 104 (which may be all of the power produced by the renewable energy source 104).

At 728, the service provider 102 may determine a length of time for the forward contract based at least in part on the term of the PSA 114. For example, if the term of the PSA is one year, the determined length of time may be multiples of one year, etc.

At 730, the service provider 102 may solicit bids from prospective purchases of a forward contract for the amount of power from the operation 726 for the determined amount of time from the operation 728.

At 732, the service provider 102 may initiate the forward contact with a winning bidder on behalf of the sponsor 106, thereby setting a fixed purchase rate for power produced by the renewable energy source 104 during the term. By having the fixed purchase rate, the sponsor 106 may be less susceptible to the wholesale market rate 206 that would otherwise be used to purchase the power produced by the renewable energy source 106. Using the fixed purchase rate, the sponsor 106 may be able to more accurately budget costs associated with the PSA 114 and the CFD 108.

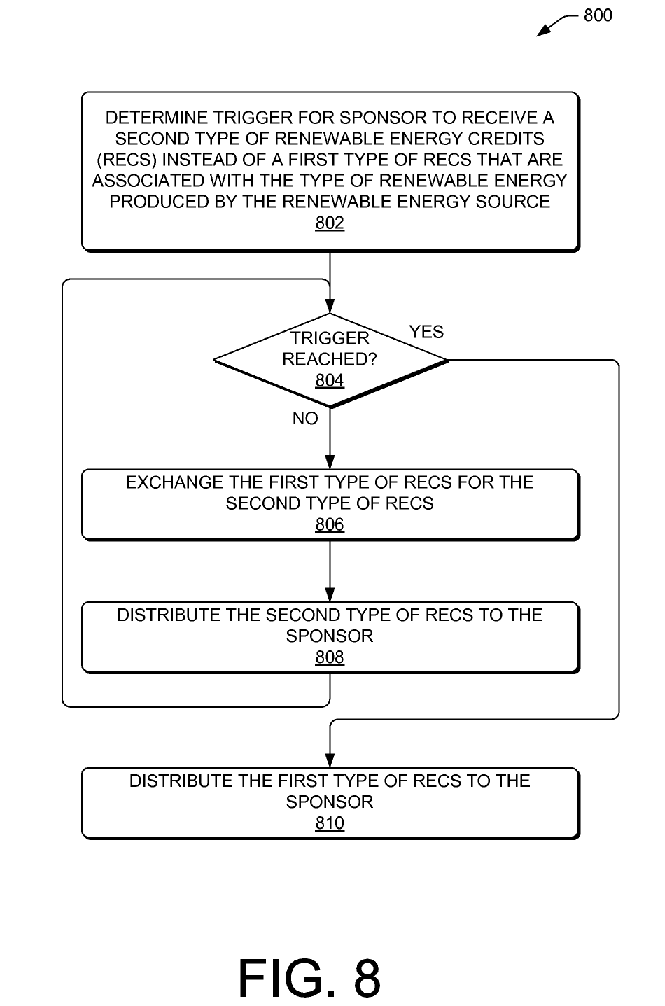

FIG. 8 is a flow diagram of an illustrative process 800 to trade renewable energy credits (RECs) associated with the renewable energy source. The process 800 may be implemented using the environment 100 and the computing architecture 300 or the process may be implemented in other environments using other computing architecture. The process 800 may be performed in part by the REC trading manager 308.

At 802, the service provider 102 may determine a trigger, such as a time period or quantity, for the sponsor 106 to receive a second type of renewable energy credits (RECs) instead of a first type of RECs that are associated with a type of renewable energy produced by the renewable energy source 104. For example, the first type of RECs may be more valuable than the second type of RECs, and thus may be traded to extract at least some of the additional value of the first type of RECs. The amount of RECs to be traded and the trigger may be specified in the REC trading agreement 322, which may be part of the CFD 108 or may be associated with the CFD 108.

At 804, the service provider 102 may determine whether the trigger has been reached, such as a time period being expired or a quantity being reached. When the trigger is not reached (following the “no” route from the decision operation 804), then the process 800 may advance to an operation 806.

At 806, the service provider 102 may exchange the first type of RECs for the second type of RECs based on the REC trading agreement 322.

At 808, the service provider 102 may distribute the second type of RECs to the sponsor 106. Following the operation 808, the process 800 may return to the decision operation 804, such as when a next issuance of RECs is expected to be received.

When the trigger is reached (following the “yes” route from the decision operation 804), then the process 800 may advance to an operation 810. At 810, the service provider 102 may distribute or cause distribution of the first type of RECs to the sponsor 106. In some embodiments, other factors other than the time period may be used to terminate the exchange of the first type of RECs for the second type of RECs. For example, a quantity of the RECs may be used in the decision operation 804 as one of many alternative criterions.

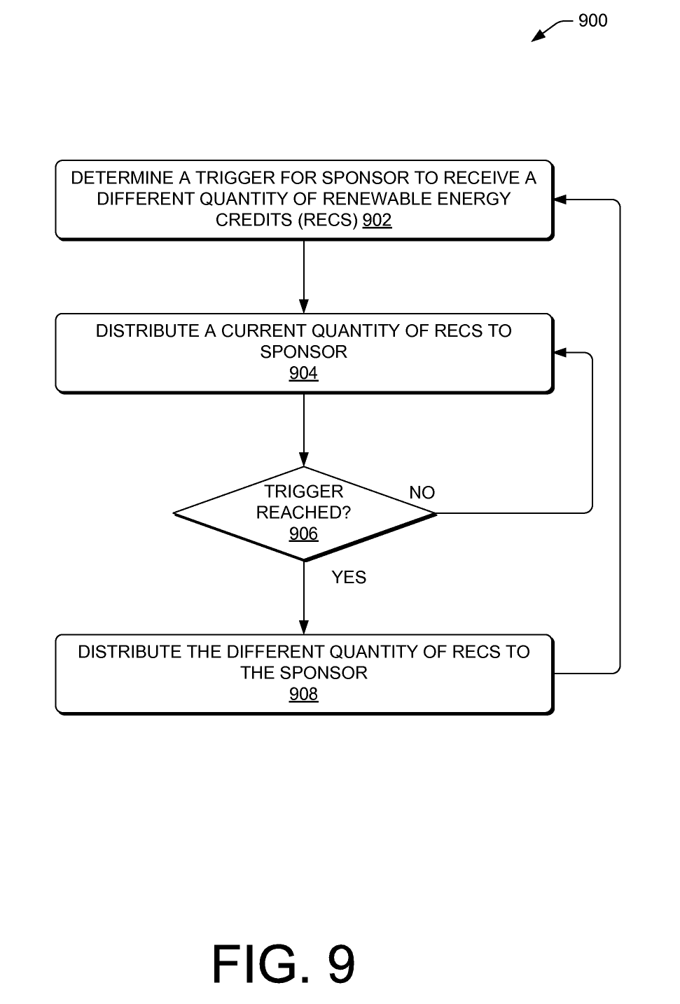

FIG. 9 is a flow diagram of another illustrative process 900 to trade renewable energy credits (RECs) associated with the renewable energy source. The process 900 may be implemented using the environment 100 and the computing architecture 300 or the process may be implemented in other environments using other computing architecture. The process 900 may be performed in part by the REC trading manager 308.

At 902, the service provider 102 may determine a trigger for the sponsor 106 to receive a different quantity of renewable energy credits (RECs). For example, under the REC trading agreement 322, the sponsor 106 may initially receive a first number of REC credits. Over time (or another trigger), the sponsor 106 may receive more (or possibly fewer) RECs after the trigger is reached.

At 904, the current quantity of RECs may be distributed to the sponsor 106.

At 906, the service provider 102 may determine whether the trigger has been reached. When the trigger has not been reached (following the “no” route from the decision operation 804), then the process 900 may return to the operation 904.

When the trigger has been reached (following the “yes” route from the decision operation 804), then the process 900 may advance to an operation 908. At 908, a different current quantity of RECs may be distributed to the sponsor 106.

The process 900 may continue from the operation 908 to the operation 902 to include further updates of the quantity, which may be increases or decreases of the quantity.

In some embodiments, the process 900 may be implemented with the process 800 to enable variation of quantities and types of RECs under the REC trading agreement 322. The processes 800 and/or 900 may include periods where no RECs are provided to the sponsor. These periods may be during the start, middle and/or end of the term of the CFD 108 and/or the REC trading agreement 322.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method comprising:
implementing a contract for differences (CFD) between a sponsor and a renewable energy source to establish a fixed rate for renewable energy produced by the renewable energy source during a term;
for each period of the term and under control of one or more computing devices:
determining a fixed rate value based on a fixed rate specified in the CFD and an amount of the renewable energy produced during the period;
determining a market rate income based on sale of the renewable energy produced during the period and sold at a wholesale market rate; and
determining a difference between the fixed rate value and the market rate income during the period;
determining, by the one or more computing devices, an aggregate difference based on the difference for each period of the term;
in response to the aggregate difference indicating that the market rate income is greater than the fixed rate value, generating a payment request to pay the sponsor the aggregate difference;
in response to the aggregate difference indicating that the market rate income is less than the fixed rate value, generating a collection request to bill the sponsor the aggregate difference; and
transferring at least a portion, but not all, of renewable energy credits (RECs) associated with the renewable energy source for the term to the sponsor.

2. The method as recited in claim 1, further comprising:
determining whether the aggregate difference is more than an absolute threshold amount or an absolute threshold percent different than a budgeted aggregate difference; and
when the aggregate difference reaches or exceeds the absolute threshold amount or the absolute threshold percent, implementing an offset process to offset the aggregate difference.

3. The method as recited in claim 2, wherein the offset process includes initiating use of a line of credit to reduce at least part of the aggregate difference.

4. The method as recited in claim 2, wherein the offset process includes initiating purchase of an amount of power on the open market that corresponds to an amount of power produced and sold on a wholesale market during a same period of time.

5. The method as recited in claim 4, wherein the purchase of the amount of power on the open market is temporally correlated to align with an actual amount sold during increments of the period on the open market at the wholesale market price.

6. The method as recited in claim 2, wherein the offset process includes initiating a forward contract for sale of at least some power generated by the renewable energy source for a period of time.

7. The method as recited in claim 6, further comprising soliciting bids to initiate the forward contract.

8. The method as recited in claim 1, wherein the renewable energy source generates solar power.

9. The method as recited in claim 1, wherein the CFD specifies receipt by the sponsor of RECs of a first type during a first part of a term of the CFD and RECs of a second type during a second part of the term.

10. The method as recited in claim 9, further comprising trading the second type of RECs for the first type of RECs.

11. The method as recited in claim 1, further comprising generating a budget forecast of payments due or payments to be received by the sponsor under the CFD.

12. The method as recited in claim 11, further comprising forecasting production of power by the renewable energy source for use in the budget forecast.

13. One or more computer-readable media storing computer-executable instructions that, when executed on one or more processors, performs acts comprising:
determining a fixed rate value based on a fixed rate and amount of renewable energy produced during the period, the fixed rate being specified in a contract for differences (CFD) between a sponsor and a renewable energy source;
determining a market rate income based on sale of the renewable energy produced during the period and sold at a wholesale market rate;
determining a difference between the fixed rate value and the market rate income during the period;
determining an offset to be applied to the difference between the fixed rate value and the market rate income during the period, the offset to reduce the difference;
in response to the fixed rate value being greater than the market rate value after application of the offset, indicating a payment is due to the renewable energy source from the sponsor for the difference; and
in response to the fixed rate value being less than the market rate value after application of the offset, indicating a payment is due to the sponsor from the renewable energy source for the difference.

14. The one or more computer-readable media as recited in claim 13, wherein the offset is at least one of:
a line of credit to fund at least part of the aggregate difference;
a purchased amount of power on the open market that corresponds to an amount of power produced and sold on a wholesale market during a same period of time; or
a forward contract for sale of at least some power generated by the renewable energy source for a period of time.

15. The one or more computer-readable media as recited in claim 13, wherein the CFD includes receipt by the sponsor of renewable energy credits (RECs) of a first type during a first part of a term of the CFD and RECs of a second type during a second part of the term, and wherein the acts further comprise trading the second type of RECs for the first type of RECs.

16. The one or more computer-readable media as recited in claim 13, wherein the renewable energy source generates solar power.

17. A system, comprising:
one or more processors;
one or more memories in communication with the one or more processes; and
a finance manager stored in the one or more memories and executable by the one or more processors to facilitate obligations under a contract for differences (CFD) between a sponsor and a solar energy source that establishes at least a fixed rate for solar energy produced by the solar energy source during a term, the finance manager to:
determine a fixed rate value based on a fixed rate and amount of the solar energy produced during the period;
determine a market rate income based on sale of the solar energy produced during the period and sold at a wholesale market rate;
determine a difference between the fixed rate value and the market rate income during the period;
in response to the fixed rate value being greater than the market rate value, indicate a payment is due to the solar energy source from the sponsor for the difference; and
in response to the fixed rate value being less than the market rate value, indicate a payment is due to the sponsor from the solar energy source for the difference.

18. The system as recited in claim 17, wherein the finance manager further includes an offset module stored in the one or more memories and executable by the one or more processors to:
in response to the difference reaching or exceeds an absolute threshold amount or an absolute threshold percent, implement an offset process to reduce the difference.

19. The system as recited in claim 18, wherein the offset process includes one or more of:
initiating use of a line of credit to fund at least part of the aggregate difference;
initiating purchase of an amount of power on the open market that corresponds to an amount of power produced and sold on a wholesale market during a same period of time; or
initiating a forward contract for sale of at least some power generated by the solar energy source for a period of time.

20. The system as recited in claim 17, further comprising a renewable energy credits (RECs) trading module stored in the one or more memories and executable by the one or more processors to facilitate trading a first type of RECs generated by the solar energy source for a second type of RECs and providing the second type of RECs to the sponsor of the CFD.
